(19) United States
(12) Patent Application Publication
(10) Pub. No.: US 2013/0119597 A1
(43) Pub. Date: May 16, 2013

(54) Raised, Space Saving Cutting Board

(71) Applicant: Dane Sorensen, Issaquah, WA (US)

(72) Inventor: Dane Sorensen, Issaquah, WA (US)

(21) Appl. No.: 13/677,220

(22) Filed: Nov. 14, 2012

Related U.S. Application Data
(60) Provisional application No. 61/559,249, filed on Nov. 14, 2011.

(51) Int. Cl. A47J 47/00

(52) U.S. Cl. CPC A47J 47/005
USPC 269/289 R

(57) ABSTRACT

A cutting board used on a standard height counter of work table in a food preparation area that includes an elevated, raised horizontally aligned planar panel that enables a chef to stand upright and thereby reduces back strain. The planar panel is supported by two downward extending, perpendicularly aligned vertical side panels. The widths and lengths of the planar panel and the side panels are sufficiently and the side panels are sufficiently spaced apart on the planar panel to create a lower rectangular storage cavity that can receive a ‘hotel pan’. The side panels are aligned inward and slightly offset from the lateral edges of the planar panel to form lateral overhanging edges that can extend over the edge of the ‘hotel pan’ when the ‘hotel pan is placed on the work table adjacent to the cutting board. The cutting board is made of plastic or other dishwasher compatible material.

This utility patent application is based on and claims the priority filing date of U.S. provisional patent application (Application No. 61/559,249), filed on Nov. 14, 2011.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention pertains to food cutting boards, and more particular to cutting boards that reduce back stress on a chef, allow cut food to be easily deposited from the cutting board directly into a standard food preparation pan, and allows for empty food preparation pans to be conveniently stored nearby and repositioned adjacent cutting board.

2. Description of the Related Art

In large kitchens, chefs must repeatedly clean, cut and prepare different types of food that are used in different meals. The food may be immediately cook or temporarily stored and cooked later in the day.

Most kitchens have designated areas where the food is washed and cut prior to cooking. In large kitchens where hundreds of meals are prepared each day, chefs must stand in one location adjacent to the food preparation area for several hours washing and cutting food. Because most food preparation areas include counters and work tables at a fixed height, (i.e. typically 30 inches in height), many chefs of average height or greater experience back problems caused by having to leaning forward over the counter and work tables for several hours. FIG. 1 is an illustration showing a chef 90 preparing food 100 using a standard, flat cutting board 94 placed directly on the counter or work table 96.

Many restaurants use standard size 16 inch×15 inch×4 inch rectangular metal or plastic trays (called “hotel pans’) to temporarily hold the washed or cut food before it is cooked. Because different meals may include the same ingredients, a chef will place several clean “hotel pans' on the counter or work area and deposit the cut food from the cutting board after into a nearby ‘hotel pan’. Unfortunately, cutting boards commonly used are directly placed on the counter or work area and occupy space thereby reducing the amount of space for ‘hotel pans’.

Municipality health codes require that work preparation areas in a kitchen be regularly washed and kept clean of debris and cuttings at all times. When cut food must be transferred from the cutting board to the ‘hotel pan’, the cutting board must be manually lifted off the counter and tilted so that one edge extends over the ‘hotel pan’. As the cutting board is being held, the other hand is used to push and scrap the cut food into the ‘hotel pan’. Unfortunately, as the cutting board is lifted and tilted, water, juices and small food particles often drip or fall from the cutting board onto the food preparation area or onto the floor. The chef is then required to stop and clean-up the spill.

What is needed is a raised cutting board that can be used on a standard height food preparation counter that is elevated above the counter or work table thereby enabling the chef to stand upright and reduce back strain, and configured so that a ‘hotel pan” may be easily placed against one side, and if desired, temporarily stored under the cutting board to maximize space on the work area.

### SUMMARY OF THE INVENTION

At the heart of the invention is the discovery that the back strain many taller chefs endure is caused by standing for long periods washing and cutting food on a food preparation surface that is a standard height (approximately 30 inches), and that be elevating the cutting board used in the food preparation surface, back strain is reduced. Also, at the heart of the invention is the discovery that storage space for empty or partially filled ‘hotel pans’ on the food preparation surface, can be increased, if the space under the cutting board is occupied by a ‘hotel pan’. Further, another discovery is that by elevating the cutting board on the food preparation surface so that the edge of the cutting board is elevated and partially extends over the sides of a ‘hotel pan’, food and liquid droppings onto the floor or food preparation surface when depositing the food into the ‘hotel pan’ is reduced thereby creating improved sanitary conditions.

Disclosed herein is an elevated cutting board to be used on a standard height food preparation surface that sufficiently elevates the surface used to clean and cut food above the food preparation surface thereby reducing back strain. The cutting board includes a top planar panel with two parallel, downward extending vertical side panels. The side panels are perpendicularly aligned to the top planar panel. The width and length of the top planar panel are sufficient and the spacing of the side panels attached thereto is sufficient to support the panel panel when washing or cutting food but also create a lower storage cavity configured to house a ‘hotel pan’ that is ready to be filled with food. The storage cavity includes front and rear openings that enable a ‘hotel pan’ to be easily slid over the work preparation surface and into and out of the storage cavity. The side panels are slightly recessed from the side edges of the top planar panel thereby enabling the lateral edges of the top planar panel to overhang the side wall of a ‘hotel pan’ when directly placed against the outside surface of a side panel.

In a second embodiment, the raised cutting board is smaller and designed for home owners. The smaller raised cutting board may be sold and distributed with small pans with lids designed to fit inside the storage space.

The cutting board is made of stainless steel or smooth, dishwasher safe, non-porous plastic.

### DESCRIPTION OF THE DRAWINGS

FIG. 1 is an illustration of a chef in the prior art standing adjacent to and bending over a food preparation work area cutting food.

FIG. 2 is a top plan view of the raised cutting board disclosed herein.

FIG. 3 is a front elevation view of the raised cutting board with a ‘hotel pan’ placed into the storage area.

FIG. 4 is an illustration the raised cutting board with a ‘hotel pan’ placed adjacent to a side panel and showing the top planar panel's overhanging edge positioned over the side wall of the pan so that food may be scrapped off the cutting board and deposited directly into the ‘hotel pan’.

FIG. 5 is a second embodiment of the raised cutting board that is smaller than the first embodiment of the raised cutting board and sold as a kit with small food storage pan and lid.

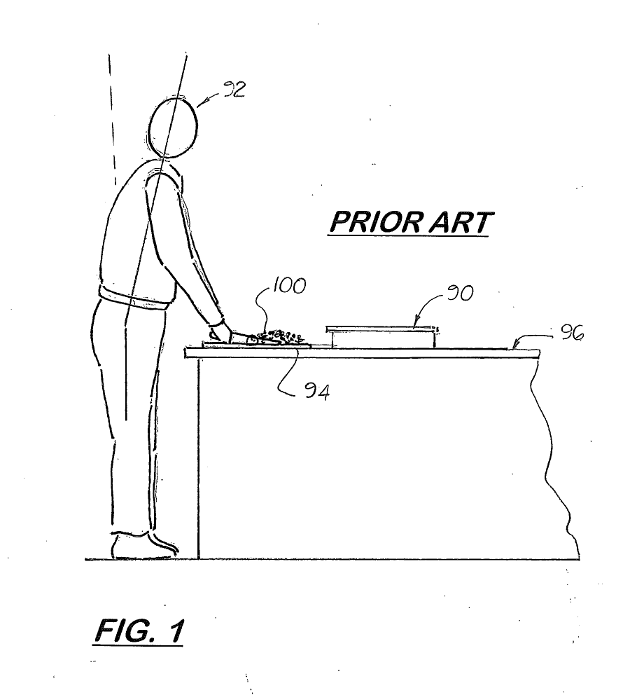

### DESCRIPTION OF THE PREFERRED EMBODIMENT(S)

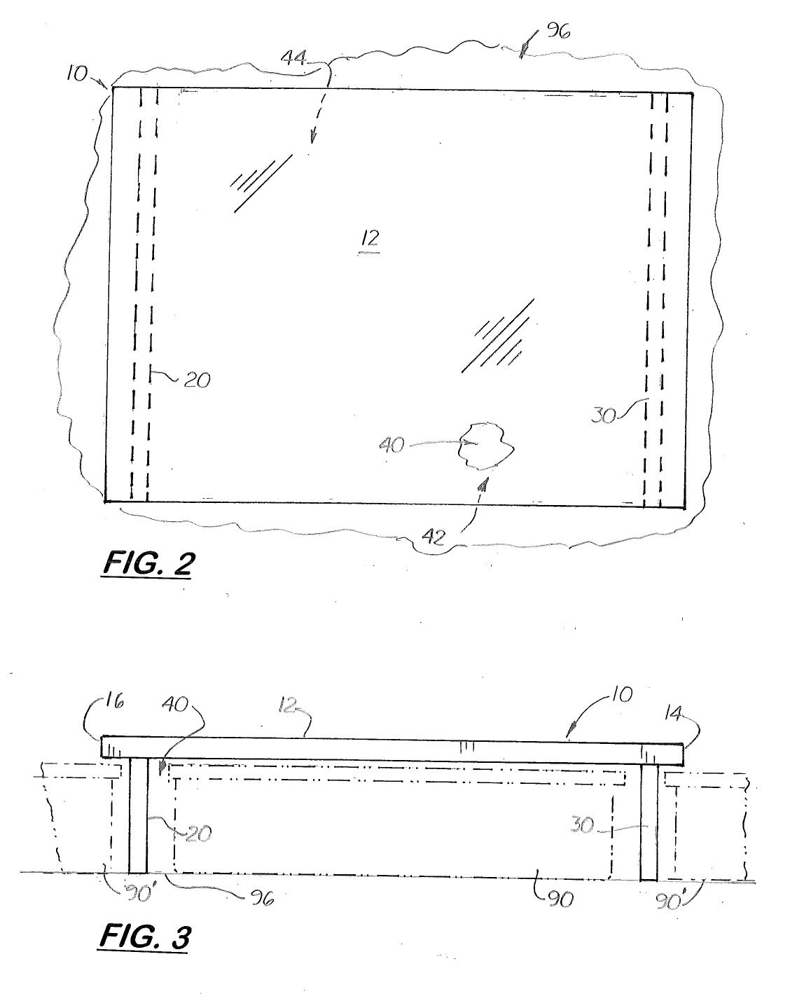

Referring to the accompanying FIGS. 2-4, there is shown an elevated or raised cutting board 10 that includes a top planar panel 12 and two downward extending, vertical side panels 20, 30. The side panels 20, 30 are parallel to each other and perpendicularly aligned to and extend downward from the bottom surface of the top planar panel 12. The width and length of the top planar panel 12 and the side panels 20, 30 are sufficiently spaced apart so that a standard ‘hotel pan’ 90 may be placed in the storage cavity formed 40 under the top planar panel 12 and between the two side panels 20, 30. Front and rear openings 42, 44 are formed into the storage cavity 40 thereby enabling a ‘hotel pan’ 90 to be easily slid into and out of the storage cavity 40. It should be understood that the term ‘hotel pan’ is a particular type of four sided-rectangular pan used to temporarily store freshly washed, recently cut or prepared food in a kitchen. Such pan's typically include a closed flat bottom and wide top open, and four vertically (or slightly diagonally) aligned side walls. Such pans measure approximately 16 inches in width, 15 inches in length, and 4 inch in height. They are usually made of dishwasher safe material such as stainless steel, aluminum, or plastic.

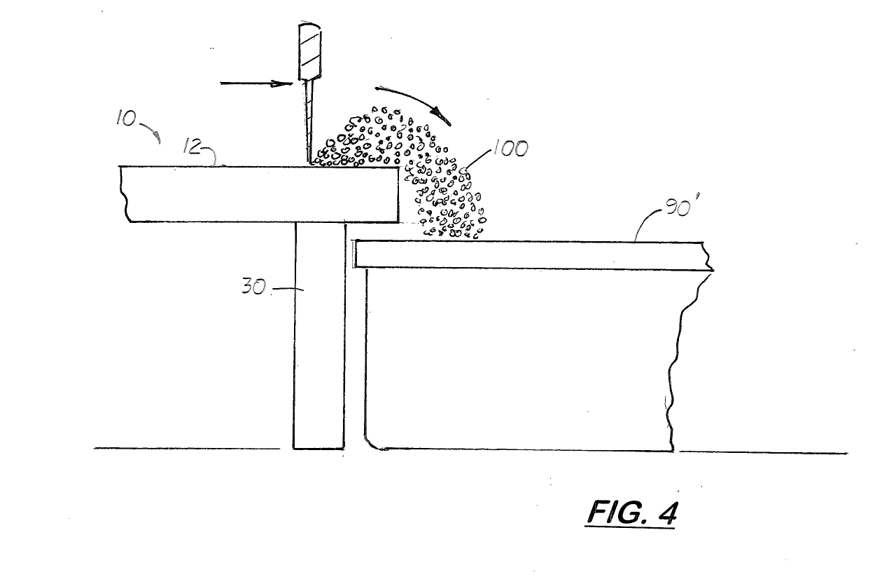

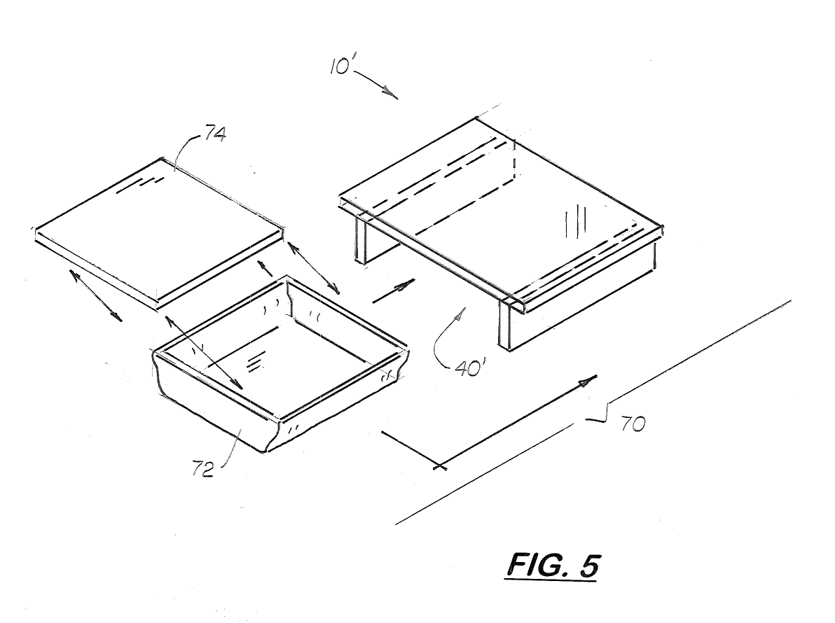

As shown more clearly in FIG. 4, the side panels 20, 30 are slightly recessed from the outside side edges 14, 16 of the top planar panel 12 thereby enabling the outside side edges 14, 16 extend over the adjacent side wall of ‘hotel pan’ 90 when the ‘hotel pan’ 90 is placed directly against to the outside surface of a side panel 20 or 30. In the preferred embodiment, the side panels 20, 30 are both recessed thereby thereby forming overlapping edges on opposite sides of the cutting board 10 so that two ‘hotel pan's 90, 90’ may be used simultaneously as shown in FIG. 3.

In the preferred embodiment, the top planar panel 12 measures approximately 21 inches in length, 15 inches in width and approximately ¾ to 1 inch thick. The side panels 20, 30 measure approximately 15 inches in length and 4¼ inches in width. The side panels 20, 30 are approximately ¾ to 1 inch thick and aligned inward to create an approximate 1 inch overhang. The storage space 40 measures approximately 21 inches in width, 18 inches in length, and 4¼ inches in height.

In a second embodiment, shown in FIG. 5 in which the raised cutting board 10′ is smaller than the first embodiment of the cutting board 10. Because ‘hotel pans’ 90 are larger, than a standard cooking pan commonly used in a home kitchen, the smaller raised cutting board 10′ may be sold as a kit 70 that includes a small food storage pan 72 designed to slide inside the board's storage space 40′. The small food storage pan 72 may include an optional lid 74.

The smaller raised cutting board 10′ measures 13 inches in length, 9 inches in width, and 3½ inches in height. The storage cavity 40 measures 9 inches in length, 9 inches in width, and 3 inches in height.

The cutting boards 10 and 10′ are made of stainless steel or smooth, dishwasher safe, non-porous plastic.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A cutting board comprising:
a. a top planar panel; and,
b. two downward extending, vertical aligned, parallel side panels attached or formed on the top planar panel, the widths and lengths of the top planar panel and the two side panels are sufficiently and the two side panels are sufficiently spaced apart to form a storage space under the top planar panel configured to hold a complimentary shaped food storage pan may be placed under the top planar panel and in between the two side panels, at least one side panel being slightly recessed from an edge of the top planar panel thereby enabling the top planar panel to overhang a side wall on a food storage pan when the food storage pain is positioned adjacent to the cutting board and the pan's side wall is positioned against the side panel.

2. The cutting board as recited in claim 1, wherein said top planar panel and said side panels are configured so that the top surface is elevated 5 to 6 inches above a work preparation surface.

3. The cutting board as recited in claim 1, wherein the cooking board is made of dishwasher safe material.

4. The cutting board as recited in claim 1, wherein the storage space formed under the top planar panel and between the two side panels measures approximately 21 inches in width, 18 inches in length, and 4¼ inches in height.

5. The cutting board, as recited in claim 1, wherein each said panel is being slightly recessed from an edge of the top planar panel thereby enabling the opposite side edges of the top planar panel to overhang a side wall on a food storage pan when the food storage pain is positioned adjacent to the cutting board and the pan's side wall is positioned against the side panel.

6. The cutting board as recited in claim 5, wherein the storage space formed under the top planar panel and between the two side panels measures approximately 21 inches in width, 18 inches in length, and 4¼ inches in height.

7. The cutting board as recited in claim 6, wherein the cooking board is made of dishwasher safe material.
